(19) United States
(12) Patent Application Publication
(10) Pub. No.: US 2016/0086750 A1
(43) Pub. Date: Mar. 24, 2016

(54) ROCKER SWITCH AND LUMINAIRE WITH ROCKER SWITCH

(71) Applicant: Flextronics Automotive GmbH & Co. KG, Filderstadt (DE)

(72) Inventor: Viktor Loewen, Sankt Augustin (DE)

(21) Appl. No.: 14/856,997

(22) Filed: Sep. 17, 2015

(30) Foreign Application Priority Data
Sep. 23, 2014 (EP) 14186023.9

(51) Int. Cl. H01H 23/04; H01H 23/08; H01H 23/30

(52) U.S. Cl. CPC H01H 23/04; H01H 23/30; H01H 23/08; H01H 2221/07

(57) ABSTRACT

A rocker switch, in particular for an interior light in a vehicle, includes a casing, a PCB assembled in the casing, the PCB having a first contact point, and a shift paddle tiltably mounted within the casing. The shift paddle has a first contact arm wherein by operating the shift paddle the shift paddle can be brought from a central position, in which there is no contact between the first contact arm and the first contact point, into a first operation position in which said first contact arm touches the first contact point of the PCB. A first return spring is provided for, which returns the shift paddle from the first operating position into the central position.

### CROSS-REFERENCE TO RELATED APPLICATIONS

This application claims priority to European Patent Application EP 14 186 023.9 filed Sep. 23, 2014, the entire contents of which are hereby fully incorporated by reference.

### DESCRIPTION

1. Field of the Invention

It is the task of the present invention to propose a rocker switch, as well as a light with such a rocker switch, in the case of which the position of the shift paddle relative to the casing can be reliably and easily set.

2. Background of the Invention

Such a rocker switch is, for example, known from DE 1 880 359.

Rocker switches are, for instance, used for interior lighting in vehicles, in order to set various switching states of one or more illuminants.

DE 1 880 359 U discloses a rocker switch wherein the shift paddle is designed as a fork. By operating the shift paddle, a contact roller is moved towards a contact point. Two springs are supported on both sides of the casing and the shift paddle, and cause the shift paddle to return to its original position once operation of it has ended. The position of the shift paddle relative to the casing is set via a deflection arm. As a lot of components are to be found in the tolerance chain, the matching between the switch and the casing is very difficult.

### SUMMARY OF THE INVENTION

According to the invention, this task is resolved by the casing having at least one inwardly directed first casing projection, on which the return spring is supported in the central position.

The casing projection forms a stop for the return spring, so that the shift paddle can be positioned relative to the casing with a high degree of accuracy when changing over from the operating position to the central position.

In order to change the shift paddle from the central position into the operating position, the shift paddle needs to unilaterally have force applied to it in the direction of operation (towards the PCB) against the spring tension of the return spring. Once no more force is applied, the return spring causes the shift paddle to return to the central position. According to the invention, when the shift paddle is changed from the operating position into the central position a flank of the readjusting spring comes to rest on the casing projection, so that the shift paddle is no longer moved any further against the direction of operation. The central position is thus, according to the invention, defined via the casing projection, by the readjustment of the shift paddle being limited by the return spring being supported on the casing projection.

In preferred embodiments, the casing projection is preferably designed as a rib (elongated projection) on the interior wall of the casing. A rib-shaped embodiment has a particularly great degree of stability.

The casing projection preferably extends from the side of the casing opposite the PCB in the direction of the PCB. The application of force of the readjusting spring then takes effect in the direction of the projection (i.e. in the direction in which the projection extends away from the wall of the casing), in which the projection is particularly resilient.

Alternatively, the projection may, however, also extend from a lateral wall of the casing, in parallel or at a slant in relation to the PCB, the lateral wall being vertical or placed at a slant in relation to the PCB.

The readjusting spring is preferably designed as a plate spring, which is bent in a “U” shape and is supported at one end against the shift paddle and, at the other end, against the PCB or against an element rigidly connected with the PCB. The return spring is thus tensioned between the shift paddle and the PCB or an element mechanically rigidly connected with the PCB.

Alternatively, a leg spring can also be used, of which one leg is supported against the shift paddle and the other leg against the PCB or against an element mechanically rigidly connected with the PCB.

The shift paddle preferably has a rocker projection, on which the return spring is supported in the central position and in the first operating position.

The rocker projection preferably extends from the contact arm of the shift paddle in a direction parallel to the PCB, and can, for example, be designed as a cam.

In the case of a particularly preferred embodiment of the shift paddle according to the invention, the shift paddle has a second contact arm and the PCB a second contact point, wherein, by operating the shift paddle, the latter can be brought from the central position into a second operating position, in which the second contact arm contacts the second contact point of the PCB. Furthermore, in the case of this embodiment a second readjusting spring is provided for, which holds the shift paddle in the central position. The casing has at least one inwardly directed second casing projection, on which the readjusting spring is supported in the central position. The contact arms of the shift paddle are preferably to be found on opposite sides of the shift paddle. The second readjusting spring causes the shift paddle to return from the second operating position. In this way three switching positions can be implemented.

In the case of a special embodiment of the rocker switch in accordance with the invention, the shift paddle comprises a transparent light plate. The shift paddle may then simultaneously serve both as a control element for the rocker switch and a light-emitting surface of an illuminant.

The invention also concerns a luminaire, in particular an interior light for a vehicle, with the rocker switch described above, wherein a reflector and at least one illuminant are configured between the PCB and the shift paddle.

The reflector is preferably fastened to the PCB, and the return spring is supported on the reflector.

Further advantages of the invention can be seen from the description and the drawing. The above-mentioned features, as well as the further features listed, can likewise be used independently or multiple features combined as desired. The embodiments shown and described are not to be understood as a conclusive list, but should rather be treated as examples to illustrate the invention.

### BRIEF DESCRIPTION OF THE DRAWINGS

The figures show the following:

FIG. 1 is an exploded view of a luminaire in accordance with the invention having a rocker switch in accordance with the invention;

FIG. 2 is a sectional representation of the luminaire in accordance with the invention, wherein the shift paddle is arranged in a central position;

FIG. 3 is a sectional representation of the luminaire in accordance with the invention, wherein the shift paddle is arranged in a first operating position; and

FIG. 4 is a sectional representation of the luminaire in accordance with the invention, wherein the shift paddle is arranged in a second operating position.

### DETAILED DESCRIPTION OF THE PREFERRED EMBODIMENTS

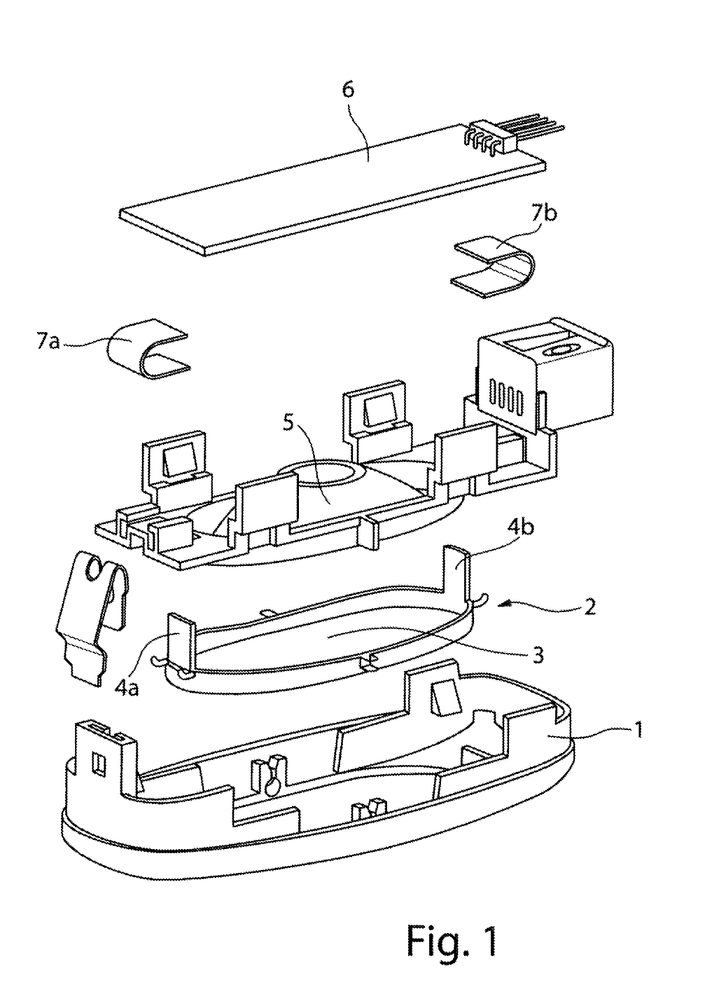

Representations of a luminaire in accordance with the invention equipped with a rocker switch in accordance with the invention are shown in FIGS. 1 to 4. The luminaire may, in particular, be utilized as an interior light for a vehicle, e.g. can be assembled as a reading light in the roof liner of the vehicle.

In FIG. 1 the individual components of the luminaire in accordance with the invention are shown in the form of a blown-up representation. The illuminant comprises a rocker switch with a casing 1, in which a shift paddle 2 is assembled in such a way that the shift paddle 2 can be operated from outside the casing 1. As the rocker switch in the present example is a luminaire, the shift paddle 2 is designed so as to be transparent and comprises a light plate 3, through which the light from the illuminants 12a, 12b can penetrate outwards. The shift paddle 2 has two contact arms 4a, 4b, which essentially extend vertically to the lens 3. The luminaire in accordance with the invention furthermore comprises a reflector 5, a PCB 6 and return springs 7a, 7b.

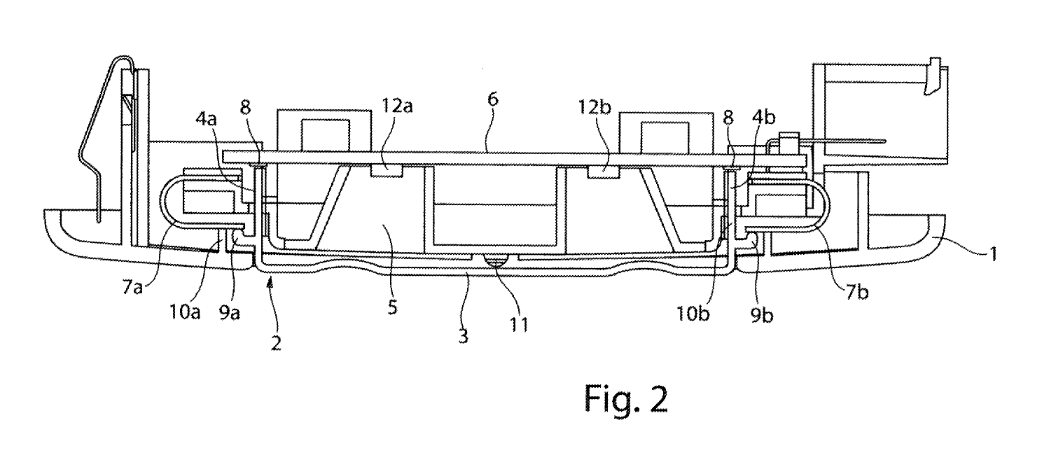

In FIG. 2 a sectional representation of the assembled luminaire is shown. The PCB 6 is equipped with two illuminants 12a, 12b, which can be switched by contacting contact points 8a, 8b of the PCB 6. The light of the illuminants 12a, 12b is reflected via the reflector 5 in the direction of the lens 3. According to the invention, the contact arms 4a, 4b of the shift paddle 2 extending in the direction of the PCB 6 serve to touch the contact points 8a, 8b.

The shift paddle 2 moreover has cam-like projections 9a, 9b, which essentially extend vertically away from the associated contact arm 4a, 4b. In the present example, plate springs, each of which is fixed with its one end attached to the reflector 5 and with its other end resting on one of the respective cam-like rocker protrusions 9a, 9b, serve as return springs 7a, 7b. The readjusting springs 7a, 7b are stretched between their attachment to the reflector 5 and the rocker protrusions 9a, 9b by means of a U-shaped bend. A force in the direction away from the PCB 6 therefore acts upon the shift paddle 2. As a result, the shift paddle 2 is held in its central position. According to the invention, the central position is defined by casing projections 10a, 10b, which extend from the interior wall of the casing in the direction of the PCB 6. The casing projections 10a, 10b form stops for the return springs 7a, 7b.

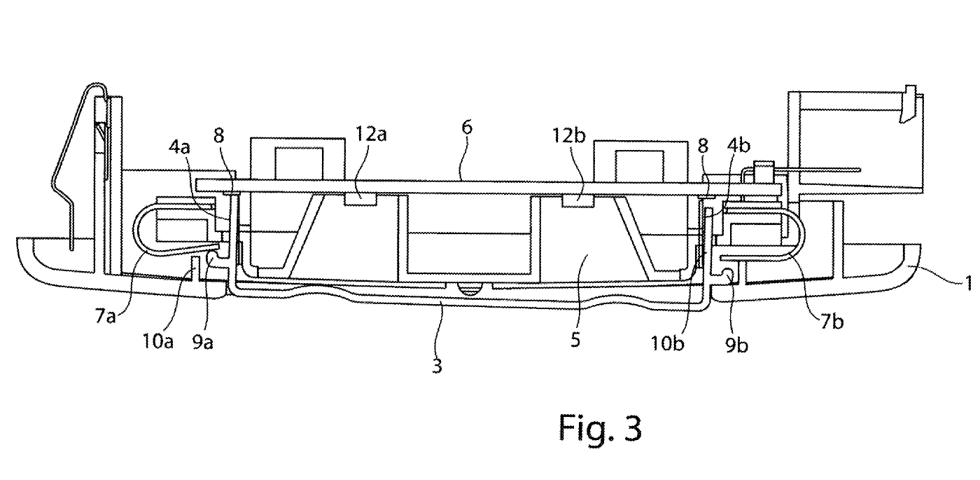

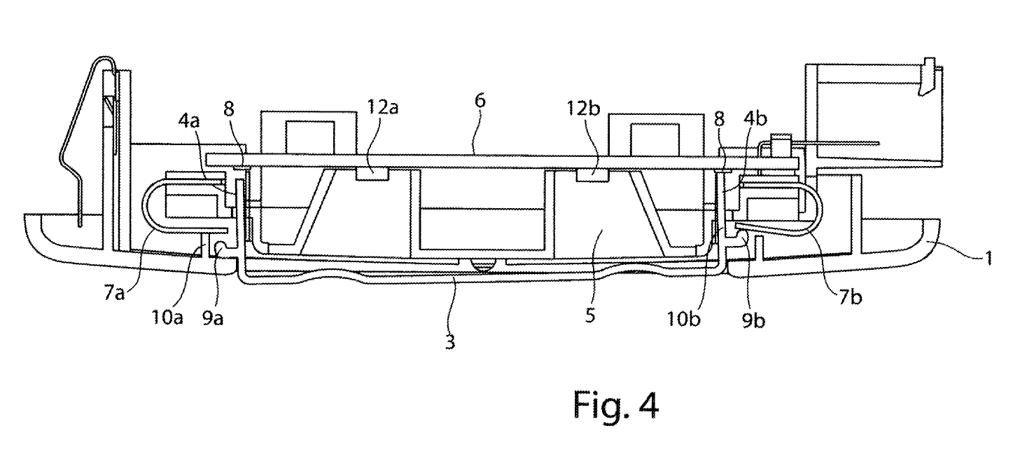

FIG. 3 shows the luminaire in accordance with the invention, wherein the shift paddle 2 is to be found in a first operating position. By applying pressure to the left half of the lens 3, the shift paddle 2 is pivoted around a fulcrum 11. This has the effect that the first contact arm 4a touches the first contact point 8a of the PCB 6, and thus a particular switching state of the illuminants 12a, 12b is brought about. Should the shift paddle 2 no longer be operated, the shift paddle 2 is returned by the readjusting spring 7a that is tensioned between the reflector 5 and the rocker projection 9a. However the shift paddle 2 only returns up to the point at which the return spring 7a comes to rest on the casing projection 9a. The shift paddle can likewise be brought into a second operating position by applying pressure on the right-hand side of the light plate 3, as shown in FIG. 4. As a result, the second contact arm 4b touches the second contact point 8b of the PCB 6, and thus causes a second switching state of the illuminants 12a, 12b to be activated. The readjustment occurs along the lines described above, by means of a second return spring 7b. The second return spring 7b moreover serves to limit the return pivoting of the shift paddle 2 from the first operating position into the central position. Thus, a reproducible position of the lens 3 in the central position is always guaranteed. The actuating force can, furthermore, be set evenly via the spring constant.

### LIST OF REFERENCE SIGNS

1 Casing
2 Shift paddle
3 Light plate
4a, 4b Contact arms
5 Reflector
6 PCB
7a, 7b Return springs
8a, 8b Contact points
9a, 9b Rocker projections
10a, 10b Casing projections
11 Fulcrum
12a, 12b Illuminants

What is claimed is:

1. A rocker switch comprising:
a casing;
a PCB assembled in the casing, the PCB having a first contact point; and
a shift paddle tiltably mounted within the casing, wherein the shift paddle has a first contact arm;
wherein by operating the shift paddle the shift paddle can be brought from a central position, in which no contact exists between the first contact arm and the first contact point, into a first operating position, in which the first contact arm contacts the first contact point of the PCB;
wherein a first return spring is provided for, which returns the shift paddle from the first operating position into the central position; and
wherein the casing has at least one inwardly directed first casing projection, on which the return spring is supported in the central position.

2. The rocker switch in accordance with claim 1, wherein the casing projection is formed as a rib on the interior wall of the casing.

3. The rocker switch in accordance with claim 1, wherein the casing projection extends from the side of the casing opposite the PCB in the direction of the PCB.

4. The rocker switch in accordance with claim 1, wherein the casing projection extends from a lateral wall of the casing, or in parallel or at a slant in relation to the PCB, the lateral wall being vertical or at a slant to the PCB.

5. The rocker switch in accordance with claim 1, wherein the readjusting spring is designed as a plate spring, which is bent in a “U” shape and is supported at one end against the shift paddle and, at the other end, against the PCB or against an element rigidly connected with the PCB.

6. The rocker switch in accordance with claim 1, wherein the shift paddle has a first rocker projection, on which the return spring is supported in the central position and in the first operating position.

7. The rocker switch in accordance with claim 1, wherein the shift paddle has a second contact arm and the PCB has a second contact point, wherein, by operating the shift paddle, the latter can be brought from the central position into a second operating position, in which the second contact arm contacts the second contact point of the PCB; wherein a second readjusting spring is provided for, which holds the shift paddle in the central position; and wherein the casing has at least one inwardly directed second casing projection, on which the readjusting spring is supported in the central position.

8. The rocker switch in accordance with claim 1, wherein the shift paddle comprises a transparent light plate.

9. The rocker switch in accordance with claim 1, wherein the rocker switch is suitable for an interior light of a vehicle.

10. A luminaire as an interior light for a vehicle with a rocker switch in accordance with claim 8, wherein a reflector and an illuminant are placed between the PCB and the shift paddle.

11. The luminaire in accordance with claim 10, wherein the reflector is attached to the PCB and the return spring is supported on the reflector.

12. A rocker switch, comprising:
a casing;
a fulcrum attached to the casing;
a shift paddle movably mounted within the casing, wherein a center portion of the shift paddle abuts the fulcrum and the shift paddle is pivotable about the fulcrum, wherein the shift paddle has a first end opposite a second end, where the first and second ends are disposed evenly about the center portion, wherein a first contact arm is at the first end and a second contact arm is at the second end, and wherein the shift paddle includes a transparent or translucent plate;
a PCB assembled in the casing positioned generally parallel to the shift paddle in a neutral position, wherein the PCB has a first contact point aligned with the first contact arm of the shift paddle and a second contact point aligned with the second contact arm of the shift paddle, and wherein the PCB includes at least one illuminant configured to illuminate towards the transparent or translucent plate;
a first spring biased against the casing at its one spring end and at its other spring end biased against either the first end of the shift paddle or against a first casing projection;
a second spring biased against the casing at its one spring end and at its other spring end biased against either the second end of the shift paddle or against a second casing projection;
wherein the shift paddle in the neutral position has the first and second springs both biased against their respective first and second ends of the casing and the first contact arm and second contact arm are not in contact with the first contact point and second contact point;
wherein the shift paddle can be pivoted by a user about the fulcrum into a first position by pressing against the shift paddle near the first end causing the first spring to be compressed further and the second spring to come to a stop against the second casing projection, the first position now having contact between the first contact arm and the first contact point; and
wherein the shift paddle can be pivoted by the user about the fulcrum into a second position by pressing against the shift paddle near the second end causing the second spring to be compressed further and the first spring to come to a stop against the first casing projection, the second position now having contact between the second contact arm and the second contact point.
